(19) United States
(12) Patent Application Publication
(10) Pub. No.: US 2019/0118619 A1
(43) Pub. Date: Apr. 25, 2019

(54) SYSTEM AND METHOD OF CONTROLLING AIR CONDITIONING SYSTEM FOR VEHICLE

(71) Applicants: Hyundai Motor Company, Seoul (KR); Kia Motors Corporation, Seoul (KR)

(72) Inventors: Jae Yeon Kim, Hwaseong (KR); Jai Young An, Suwon (KR); Kwang Woon Cho, Yongin (KR); Tae Han Kim, Seoul (KR); Wan Je Cho, Hwaseong (KR); Ho Gyu Choi, Yongin (KR); Seung Ho Lee, Seoul (KR); Eon Soo Yun, Hwaseong (KR); Jeong Yeop Woo, Incheon (KR); Boram Yang, Pyeongtaek (KR); Myunghwan Kim, Hwaseong (KR); Yong Hyun Choi, Hwaseong (KR); Gun Goo Lee, Suwon (KR)

(21) Appl. No.: 15/821,956

(22) Filed: Nov. 24, 2017

(30) Foreign Application Priority Data
Oct. 23, 2017 (KR) 10-2017-0137560

(51) Int. Cl. B60H 1/32; B60H 1/00

(52) U.S. Cl. CPC B60H 1/3216; B60H 1/3208; B60H 1/00971

(57) ABSTRACT

A method of controlling an air conditioning system for a vehicle is provided. The method includes setting a scheduled heating and performing charging of the battery and the scheduled heating. A desire target temperature (DTT) of a user is then received and a discharge temperature of air supplied into the vehicle is compared with the DTT to adjust revolutions per minute (RPM) of a compressor. When the RPM of the compressor is adjusted the RPM of the compressor is determined based on whether the discharge temperature is the same as the DTT, and whether to operate the electric heater is determined.

### CROSS-REFERENCE TO RELATED APPLICATION

This application claims priority to and the benefit of Korean Patent Application No. 10-2017-0137560 filed on Oct. 23, 2017, the entire contents of which are incorporated herein by reference.

### BACKGROUND

### (a) Field of the Invention

The present invention relates to a system and method of controlling an air conditioning system for a vehicle, and more particularly, to a system and method of controlling an air conditioning system for a vehicle, which charges a vehicle based on a scheduled heating time set in an electric vehicle, collects heat energy generated from a battery and an electronic component during charging, and uses the collected heat energy for the scheduled heating.

### (b) Description of the Related Art

In general, a vehicle includes an air conditioning system that cools and heats an interior place. The air conditioning system maintains an interior temperature of the vehicle at an appropriate temperature regardless of a change in an outside temperature and is configured to heat or cool the interior place of the vehicle by a heat exchange by an evaporator in a process in which a refrigerant discharged by driving a compressor passes through a condenser, a receiver drier, an expansion valve, and an evaporator and is then circulated to the compressor again. In other words, in a cooling mode, in the air conditioning system, a high-temperature and high-pressure gas phase refrigerant compressed by the compressor is condensed through the condenser and then is evaporated in the evaporator through the receiver drier and the expansion valve to decrease an interior temperature and humidity.

Recently, as interests in energy efficiency and an environmental contamination issue are increasing, there is a need for developing an environmentally-friendly vehicle that is capable of substantially replacing an internal-combustion engine vehicle, the environmentally-friendly vehicle which is commonly divided into an electric vehicle that is driven using a fuel cell or electricity as a power source and a hybrid vehicle that is driven using an engine and an electric battery.

Herein, the air conditioning system applied to the electric vehicle has the same general principle in a cooling mode in which a high-temperature and high-pressure gas-phase refrigerant compressed by a compressor is condensed through a condenser and then is evaporated in an evaporator through a receiver drier and an expansion valve to decrease an interior temperature and humidity, but has a characteristic in that the high-temperature and high-pressure gas-phase refrigerant is used as a heater medium in a heating mode.

However, when a user sets a scheduled heating in advance of using the vehicle, the air conditioning system applied to the electric vehicle in the related art is required to increase a temperature of air blown into an interior of the vehicle using an electric heater disposed in a heating, ventilation, air conditioning (HVAC) module. Accordingly, an excessive use of the electric heater, to which power is supplied from the battery, decreases the quantity of charging of the battery, and increases the quantity of use of the battery. Further, when the user operates the vehicle in which the scheduled heating is performed, a total travelling distance of the vehicle is decreased due to the decrease in the quantity of charging and the increase in the quantity of use of the battery.

The above information disclosed in this section is merely for enhancement of understanding of the background of the invention and therefore it may contain information that does not form the prior art that is already known in this country to a person of ordinary skill in the art.

### SUMMARY

The present invention provides a method of controlling an air conditioning system for a vehicle, which charges a vehicle based on a scheduled heating time set in an electric vehicle, collects heat energy generated from a battery and an electronic component during charging, and uses the collected heat energy in scheduled heating, thereby minimizing the quantity of use of an electric heater.

An exemplary embodiment of the present invention provides a method of controlling an air conditioning system for a vehicle, which performs charging of a battery and scheduled heating during parking of the vehicle in the air conditioning system, the air conditioning system including a cooling device configured to circulate a coolant to a battery and an electronic component connected through a cooling line, a chiller connected with a connection line connected with the cooling line through a first valve and to which the coolant may be selectively introduced, and a heating, ventilation, air conditioning (HVAC) module connected with the chiller through a refrigerant line in which a refrigerant may be circulated, and is provided with an electric heater.

In particular, the method may include setting scheduled heating and performing charging of the battery and the scheduled heating; confirming a desired target temperature (DTT) of a user, and comparing a discharge temperature of air supplied into the vehicle with the DTT to adjust revolutions per minute (RPM) of a compressor; and when the RPM of the compressor is adjusted, determining the RPM of the compressor according based on whether the discharge temperature is the same as the DTT, determining whether to operate the electric heater, and terminating the operation.

The method may further include: setting a scheduled heating based on a user input; charging the battery in a parking state of the vehicle; starting the scheduled heating of the vehicle; and opening the connection line by operating the first valve, operating a water pump disposed in the cooling line, and circulating the coolant to the chiller. In the charging of the battery, the battery may be configured to receive power from a power supplying unit disposed extraneous the vehicle by a control signal of the controller.

The first valve may close the cooling line that connects a radiator disposed at a front side of the vehicle with the battery and the electronic component, and the coolant may be supplied to the chiller in a heated state while circulating the battery and the electronic component along the opened connection line and the cooling line through the operation of the water pump. The chiller may be connected with a condenser included in the air conditioning system through a second valve disposed in the refrigerant line, and may be connected with the compressor through a refrigerant connection line. When the scheduled heating of the vehicle is performed, the second valve may close the refrigerant line connected with the condenser, an expansion valve included in the air conditioning system, and an evaporator by a control signal of the controller.

Additionally, the method may include: confirming, by the controller, the DTT set during the setting of the scheduled heating by the user; determining whether the discharge temperature of the air supplied into the vehicle is less than the DTT; when the discharge temperature is less than the DTT, increasing the RPM of the compressor; and when the discharge temperature of the air supplied into the vehicle is greater than the DTT, decreasing the RPM of the compressor. The method may further include: determining whether the discharge temperature is the same as the DTT and when the discharge temperature is the same as the DTT, maintaining the RPM of the compressor; and maintaining a heating operation of the vehicle and terminating the operation.

The method may further include when the discharge temperature is different from the DTT, determining whether the RPM of the compressor is a maximum. When the RPM of the compressor is the maximum, the electric heater may be operated and the RPM of the compressor may be maintained. Additionally, when the RPM of the compressor is not the maximum, the DTT may be confirmed again.

According to the method of controlling the air conditioning system for the vehicle according to the exemplary embodiment of the present invention, it may be possible to minimize the quantity of use of the electric heater by charging the vehicle based on a scheduled heating time set in an electric vehicle, collecting heat energy generated from the battery and the electronic component during the charging, and using the collected heat energy for the scheduled heating.

Further, the method of controlling the air conditioning system for the vehicle according to the exemplary embodiment of the present invention may prevent excessive power consumption of the electric heater, thereby efficiently managing the charging completed battery and increasing an overall travelling distance of the vehicle. In addition, when the scheduled heating of the vehicle is operated, the heat energy generated from the battery and the electronic component and the electric heater may be simultaneously used, thereby decreasing power usage fees and improving marketability of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an air conditioning system to which a method of controlling an air conditioning system for a vehicle according to an exemplary embodiment of the present invention is applied; and

FIG. 2 is a control flow chart illustrating the method of controlling the air conditioning system for the vehicle according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

An exemplary embodiment of the present invention will hereinafter be described in detail with reference to the accompanying drawings. Before this, the exemplary embodiment described in the present specification and the configuration illustrated in the drawing are simply the exemplary embodiments of the present invention, and do not represent all of the technical spirits of the present invention, and thus it should be understood that there are various equivalents and modification examples substitutable with the exemplary embodiment described in the present specification and the configuration illustrated in the drawing at the time of filing the present application.

The drawings and description are to be regarded as illustrative in nature and not restrictive, and like reference numerals designate like elements throughout the specification. In addition, the size and thickness of each configuration shown in the drawings are arbitrarily shown for understanding and ease of description, but the present invention is not limited thereto. In addition, the terms “ . . . unit”, “ . . . means”, “ . . . part”, and “ . . . member” described in the specification mean units of a general configuration performing at least one function or operation.

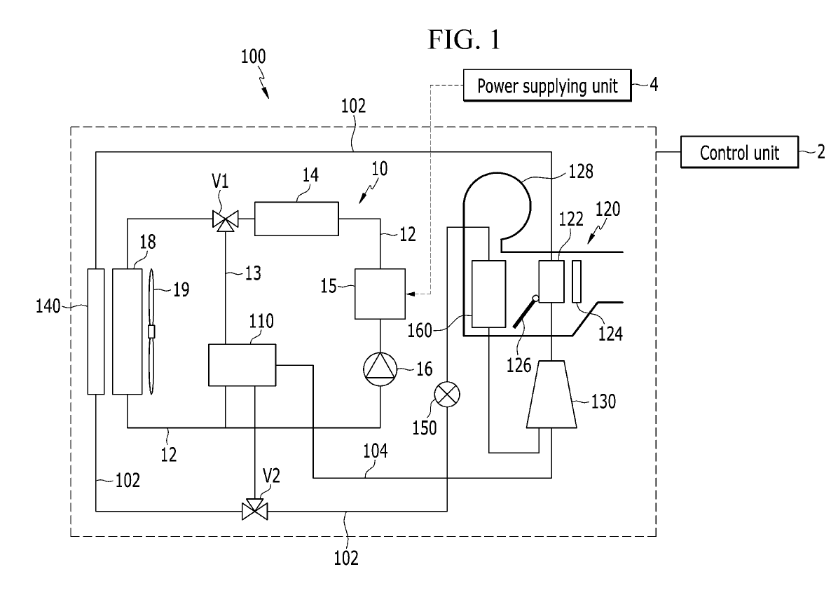

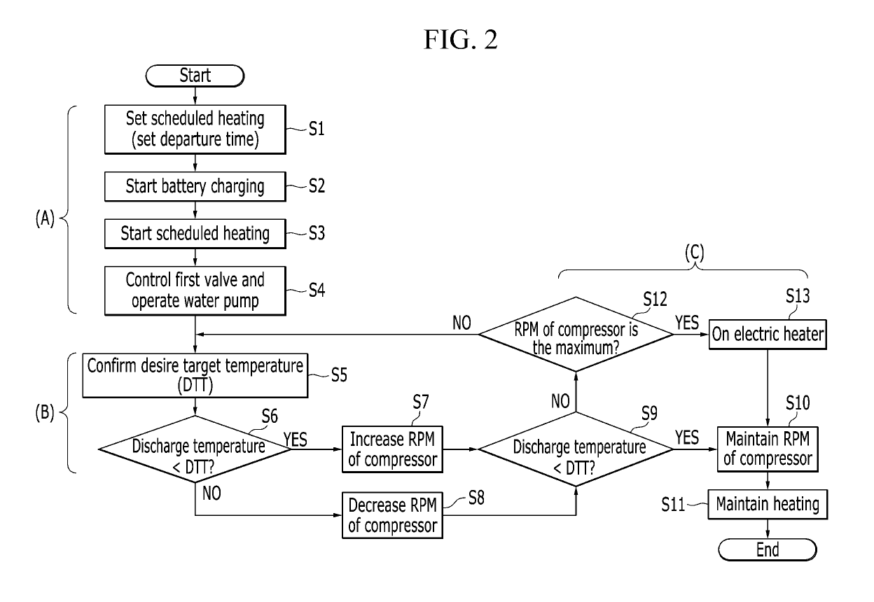

FIG. 1 is a block diagram illustrating an air conditioning system to which a method of controlling an air conditioning system for a vehicle according to an exemplary embodiment of the present invention is applied, and FIG. 2 is a control flow chart illustrating the method of controlling the air conditioning system for the vehicle according to the exemplary embodiment of the present invention. Referring to FIG. 1, a method of controlling an air conditioning system for a vehicle according to an exemplary embodiment of the present invention is applied to an air conditioning system 100 operated by a controller 2, and may be linked with a cooling device 10 within an electric vehicle. The controller 2 may be configured to operate the various components of the system and the cooling device.

In particular, the cooling device 10 may include a water pump 16 which configured to circulate a coolant to a battery 15 and an electronic component 14 connected with each other through a cooling line 12, and a radiator 18 and a cooling fan 19 disposed at a front side of the vehicle to cool the cooling completed high-temperature coolant and outside air through a heat exchange. The electronic component 14 may include an electric power control unit (EPCU) and an on board charger (OBC).

Further, the air conditioning system 100 may include a chiller 110, an HVAC module, a compressor 130, a condenser 140, an expansion valve 150, and an evaporator 160. Particularly, the chiller 110 may be connected to a connection line 13 through a first valve V1 disposed in the cooling line 12 between the electronic component 14 and the radiator 18. A coolant may be selectively introduced to the chiller 110 through the connection line 13 based on an operation of the first valve V1. The chiller 110 may be connected with the condenser 140 through a second valve V2 disposed in a refrigerant line 102, and may be connected with the compressor 130 through the refrigerant connection line 104.

The HVAC module 120 may include therein the evaporator 160 connected to the refrigerant line 102, and an opening/closing door 126 configured to which selectively adjust outside air passing through the evaporator 160 to introduce the outside air to an interior heat exchanger 122 and an electric heater 124. The electric heater 124 may be a positive temperature coefficient (PTC) heater which is operated by receiving power from a battery (not illustrated).

The HVAC module 120 may be configured to introduce, into the vehicle, air passing through the evaporator 160 by operating a blow motor 128 disposed at one side thereof or air sequentially passing through the evaporator 160, the interior heat exchanger 122, and the electric heater 124. In other words, in the HVAC module 120, the opening/closing door 126 operated by the controller 2 may be configured to selectively open or close the interior heat exchanger 122 and the electric heater 124 based on a cooling or heating mode of the interior of the vehicle, thereby adjusting a flow of air.

The compressor 130 may be connected through the refrigerant line 102 between the evaporator 160 and the interior heat exchanger 122. The compressor 130 may be provided separately from the HVAC module 130 and may be configured to compress a refrigerant in a gas state as a high-temperature and high-pressure refrigerant. The condenser 140 may be connected with the interior heat exchanger 122 through the refrigerant line 102, and may be configured to condense a refrigerant. The expansion valve 150 may be disposed in the refrigerant line 102 between the condenser 140 and the evaporator 160. The expansion valve 150 may be configured to receive and expand the refrigerant discharged from the condenser 140, and supply the expanded refrigerant to the evaporator 160. Further, the evaporator 160 may be configured to evaporate the refrigerant supplied from the expansion valve 150. The air conditioning system 100 as described above may be configured to cool or heat the vehicle by a circulation of the refrigerant.

In the present exemplary embodiment, the method of controlling the air conditioning system performs a charging of the battery 15 and scheduled heating during a parking of the vehicle, and may include setting a scheduled heating and performing charging of the battery 15 and the scheduled heating; confirming a desired target temperature (DTT) of a user, comparing a discharge temperature of air supplied into the vehicle and the DTT, and adjusting revolutions per minute (RPM) of the compressor 130, and when the RPM of the compressor is adjusted, determining the RPM of the compressor based on whether the discharge temperature is the same as the DTT, determining whether to operate the electric heater, and terminating the operation. The method described in further detailed herein below may be executed by the controller. Additionally, the termination of the operation may refer to termination of electric heater operation.

In particular, a user may set a scheduled heating before parking a vehicle (S1). The scheduled heating improves an interior temperature in accordance with an operation time of the parked vehicle in a season having a relatively low temperature (e.g., colder weather months such as winter). When the scheduled heating is set, the controller 2 may be configured to charge the battery 15 while the vehicle is parked (S2). In the charging of the battery 15 (S2), the battery 15 may be configured to receive power from a power supplying unit 4 extraneous to the vehicle by a control signal of the controller 2. When the charging of the battery 15 starts, the controller 2 may also be configured to start the scheduled heating of the vehicle by operating the cooling device 10 and the air conditioning system 100.

Further, the controller 2 may be configured to open the connection line 13 by operating the first valve V1, and circulate a coolant to the chiller 110 by operating the water pump 16 disposed in the cooling line 12 (S4). Herein, the first valve V1 may be configured to close the cooling line 12 that connects the radiator 18 with the battery 15 and the electronic component 14 by the control signal of the controller 2. Accordingly, the coolant may be supplied to the chiller 110 in a heated state while circulating the battery 15 and the electronic component 14 along the connection line 13 and the cooling line 12 that is opened through the operation of the water pump 16.

In other words, a temperature of the coolant may be increased by heat energy generated during the charging of the battery 15 and heat energy generated from a charger included in the electronic component 14. When the scheduled heating of the vehicle is performed, the second valve V2 may be configured to close the refrigerant line 102 connected with the condenser 140, the expansion valve 150, and the evaporator 160 by the control signal of the controller 2. Accordingly, the refrigerant discharged from the condenser 140 may pass through the chiller 110. In particular, the refrigerant may be supplied to the compressor 130 in a temperature increased state while exchanging heat with the high-temperature coolant introduced to the chiller 110.

Further, the refrigerant may be compressed in the compressor 130 and supplied to the interior heat exchanger 122 in a high-temperature and high-pressure state. The opening/closing door 126 may be configured to open the interior heat exchanger 122 and the electric heater 126 based on an operation of the controller 2. Accordingly, the air supplied into the vehicle from the HVAC module 120 may have an increased temperature while passing through the evaporator 160, in which the supply of the refrigerant is stopped, and passing through the interior heat exchanger 122 and the electric heater 124.

Furthermore, the controller 2 may be configured to confirm the DTT set during the setting of the scheduled heating by the user (S5). Then, the controller 2 may be configured to determine whether a discharge temperature of the air supplied into the vehicle is less than the DTT (S6). When the discharge temperature is less than the DTT, an RPM of the compressor 130 may be increased (S7). Accordingly, the refrigerant may be supplied to the interior heat exchanger 122 at a greater temperature and pressure by the compressor 130 having the increased RPM. Further, the air that is heat exchanged while passing through the interior heat exchanger 122 may be supplied into the vehicle in a state where the temperature of the air is further increased.

Additionally, when the discharge temperature is greater than the DTT, the RPM of the compressor 130 may be decreased (S8). Accordingly, the refrigerant may be supplied to the interior heat exchanger 122 at a reduced temperature and pressure by the compressor 130 of which the RPM is decreased. Further, the air that is heat exchanged while passing through the heat exchanger 122 may be supplied into the vehicle in a state where the temperature of the air is decreased.

When the RPM of the compressor 130 is adjusted, the controller 2 may be configured to determine whether the discharge temperature is the same as the DTT (S9). In particular, when the discharge temperature is the same as the DTT, the controller 2 may be configured to maintain the RPM of the compressor 130 (S10). Then, the controller 2 may be configured to maintain a heating operation of the vehicle (S11), and terminate the control.

However, when the discharge temperature is different from the DTT, the controller 2 may be configured to determine whether the RPM of the compressor 130 is a maximum (S12). When the RPM of the compressor 130 is the maximum, the controller 2 may be configured to operate the electric heater 124 (S13).

In other words, when the RPM of the compressor 130 is the maximum and the discharge temperature is different from the DTT, the discharge temperature is unable to be increased only through the heat exchange between the refrigerant and the air passing through the interior heat exchanger. Accordingly, the controller 2 may be configured to operate the electric heater 124 to thus increase the discharge temperature of the air passing through the interior heat exchanger 122 and the electric heater 124. Then, the temperature of the air passing through the electric heater 124 may be increased while the air passes through the operated electric heater 124.

Further, the controller 2 may be configured to maintain the RPM of the compressor 130 (S10) and the heating operation of the vehicle (S11) again, and terminate the control. In other words, the controller 2 may be configured to reduce or minimize the operation of the electric heater 124 operated with the power supplied from the battery 15 while performing the respective operations. Simultaneously, the quantity of use of the battery 15 may be decreased. In the meantime, when the RPM of the compressor is not the maximum, the controller 2 may return to the confirming of the DTT set during the setting of the scheduled heating by the user (S5). Then, the controller 2 may repeatedly perform the respective operations.

When the method of controlling the air conditioning system for the vehicle according to the exemplary embodiment of the present invention, which is configured as described above is applied, it is possible to minimize the quantity of use of the electric heater 124 by charging the vehicle according to a scheduled heating time set in the electric vehicle, collecting heat energy generated from the battery 15 and the electronic component 14 during the charging, and using the collected heat energy for the scheduled heating.

Further, the method of controlling the air conditioning system for the vehicle according to the exemplary embodiment of the present invention may prevent excessive power consumption of the electric heater 124, thereby efficiently managing the charging completed battery 15 and increasing an overall travelling distance of the vehicle. When the scheduled heating of the vehicle is operated, the heat energy generated from the battery 15 and the electronic component 14 and the electric heater 124 may be simultaneously used, thereby decreasing power usage fees and improving marketability of the vehicle.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

2: Controller

4: Power supplying unit

10: Cooling device

12: Cooling line

13: Connection line

14: Electronic component

16: Water pump

18: Radiator

19: Cooling fan

100: Air conditioning system

102: Refrigerant line

104: Refrigerant connection line

110: Chiller

120: HVAC module

122: Interior heat exchanger

124: Electric heater

126: Opening/closing door

128: Blow motor

130: Compressor

140: Condenser

150: Expansion valve

160: Evaporator

V1, V2: First, second valve

What is claimed is:

1. A method of controlling an air conditioning system for a vehicle, the air conditioning system including a heating, ventilation, air conditioning (HVAC) module, the method comprising:
receiving, by a controller, a scheduled heating and performing charging of the battery and the scheduled heating when the vehicle is parked;
confirming, by the controller, a desire target temperature (DTT) of a user, and comparing a discharge temperature of air supplied into the vehicle with the DTT to adjust revolutions per minute (RPM) of a compressor; and
when the RPM of the compressor is adjusted determining, by the controller, the RPM of the compressor based on whether the discharge temperature is the same as the DTT, determining whether to operate an electric heater within the system, and terminating the operation.

2. The method of claim 1, further comprising:
opening a connection line in the system by controlling a first valve, operating a water pump provided in a cooling line of the system, and circulating a coolant to a chiller to start the scheduled heating of the vehicle,
wherein the cooling device circulates the coolant through the cooling line and the chiller is connected with the connection line to the cooling line through the first valve.

3. The method of claim 2, wherein in the charging of the battery, the battery receives power from a power supplying unit disposed extraneous to the vehicle by a control signal of the controller.

4. The method of claim 2, wherein the first valve closes the cooling line that connects a radiator disposed at a front side of the vehicle with the battery and the electronic component, and the coolant is supplied to the chiller in a heated state while circulating the battery and the electronic component along the opened connection line and the cooling line through the operation of the water pump.

5. The method of claim 2, wherein the chiller is connected with a condenser of the air conditioning system through a second valve disposed in a refrigerant line, and is connected with the compressor through a refrigerant connection line.

6. The method of claim 5, wherein when the scheduled heating of the vehicle is performed, the second valve closes the refrigerant line connected with the condenser, an expansion valve of the air conditioning system, and an evaporator by a control signal of the controller.

7. The method of claim 1, further comprising:
confirming, by the controller, the DTT set during the in response to receiving a user setting of the scheduled heating;
determining, by the controller, whether the discharge temperature of the air supplied into the vehicle is less than the DTT;
when the discharge temperature is less than the DTT, increasing, by the controller, the RPM of the compressor; and
when the discharge temperature is greater than the DTT, decreasing, by the controller, the RPM of the compressor.

8. The method of claim 1, further comprising:
determining, by the controller, whether the discharge temperature is the same as the DTT;
when the discharge temperature is the same as the DTT, maintaining, by the controller, the RPM of the compressor; and
maintaining, by the controller, a heating operation of the vehicle and terminating the operation.

9. The method of claim 8, further comprising:
when the discharge temperature is different from the DTT, determining, by the controller, whether the RPM of the compressor is a maximum.

10. The method of claim 9, further comprising:
when the RPM of the compressor is the maximum, operating, by the controller, the electric heater, and maintaining the RPM of the compressor.

11. The method of claim 9, further comprising:
when the RPM of the compressor is not the maximum, confirming, by the controller, the DTT again.

12. A system of controlling an air conditioning system for a vehicle, the air conditioning system including a heating, ventilation, air conditioning (HVAC) module, the method comprising:
a memory configured to store program instructions; and
a processor configured to execute the program instructions, the program instructions when executed configured to:
receive a scheduled heating and perform charging of the battery and the scheduled heating when the vehicle is parked;
confirm a desire target temperature (DTT) of a user, and compare a discharge temperature of air supplied into the vehicle with the DTT to adjust revolutions per minute (RPM) of a compressor; and
when the RPM of the compressor is adjusted determine the RPM of the compressor based on whether the discharge temperature is the same as the DTT, determine whether to operate an electric heater within the system, and terminate the operation.
